(19) United States
(12) Patent Application Publication
(10) Pub. No.: US 2025/0085568 A1
(43) Pub. Date: Mar. 13, 2025

(54) SPRING-LOADED HINGES FOR SMARTGLASSES

(71) Applicant: Innovative Eyewear, Inc., North Miami, FL (US)

(72) Inventors: Breno Fuzette, Santa Terezinha (BR); Harrison Gross, North Miami, FL (US)

(73) Assignee: Innovative Eyewear, Inc., North Miami, FL (US)

(21) Appl. No.: 18/463,465

(22) Filed: Sep. 8, 2023

(51) Int. Cl. G02C 5/22; G02B 27/01; G02C 11/00

(52) U.S. Cl. CPC G02C 5/2227; G02B 27/0176; G02C 11/10; G02B 2027/0178; G02C 2200/26

(57) ABSTRACT

Methods, apparatus and systems directed to a spring-loaded hinge configured for use in connection with smartglasses for flexible connection between the front frame and temples of the smartglasses. In some embodiments, a spring loaded hinge may have components incorporated within a compact box housing configured to be disposed on an end piece of a smartglasses front frame, for example, as opposed to on an end piece of the temple, to improve the durability of the temples by acting as a sink for excessive bending stress on the temples, increase the flexibility of the temples with respect to the front frames, and/or make it easier to open and close the smartglasses temples.

### FIELD OF THE INVENTION

The present invention relates to the field of glasses, and in particular to spring-loaded hinges for a kind of wireless connection-enabled smartglasses.

### BACKGROUND

Spring hinges have been used in connection with eyewear to pivotally connect eyeglass temples to a front frame. The hinges are configured to allow for rotating of the temples with respect to the front frame to draw the far end of the temples towards the front frame when eyeglasses are not in use. During use, the spring hinges allow the temples to spread out further than standard hinges may allow, for example, to over-extend past a 90° angle in relation to the front frame, due to the biasing flexibility provided by the springs in the hinges. In some instances, such an assembly may increase user comfort while wearing the glasses.

The following are examples of spring hinges in the art:

U.S. Pat. No. 3,060,804 directed to an adjustable hinge for eyeglasses that allows the temples to be adjusted to different angles which can be useful for people with different head shapes or who want to wear their glasses in a variety of ways.

DE Patent 321,3174, directed to a spring hinge for eyeglasses that uses a sliding receptacle to hold a slide part.

EP U.S. Pat. No. 702,803 directed to a hinge system for eyewear that allows the temples to be detached from the frame which can be useful for cleaning or repairing eyewear.

U.S. Pat. No. 8,177,360 directed to a magnetic hinge for eyeglasses that uses magnets to hold the temples in place which can be a more durable and secure way to attach the temples to the frame.

U.S. Pat. No. 11,474,376 directed to wearable smartglasses having hinges configured to house a wire connecting the frames of the smartglasses to the temples.

WO Patent 2006024221A1, directed to a spring hinge for eyeglasses that uses a box-like housing to contain the spring and other components.

U.S. Pat. No. 7,434,295, directed to a spring hinge for eyeglasses that uses a clutch structure to keep the hinge from opening too far.

U.S. Pat. No. 7,581,289, directed to a spring hinge for eyeglasses that uses a friction hinge to provide a secure fit.

While the prior described disclosures teach a version of flexible hinges, such and similar prior-developed hinges lack a teaching of spring-loaded hinges specifically configured for use in connection with smartglasses. Moreover, these disclosures do not teach smartglasses constructs using spring-loaded hinges to allow for additional flexibility of the temples with respect to the front frames. This is perhaps due, at least in part, to the formerly bulky construction of spring-loaded hinges configured for use in connection with eyeglasses, which would be difficult to incorporate into smartglasses due to their size. For example, since smartglasses temples and/or front frames already have limited space for additional hardware due to electronics componentry taking up space within those smartglasses pieces, bulky spring-loaded hinges are difficult to incorporate into such constructs.

Therefore, there is a need in the art for a spring-loaded hinge configured for use in connection with smartglasses which is to be incorporated within a compact box housing configured to be disposed on an end piece of the front frame (as opposed to on an end piece of the temple), to improve the durability of the temples by acting as a sink for excessive bending stress on the temples, increase the flexibility of the temples with respect to the front frames, and/or make it easier to open and close the temples because of the spring tension. These and other features and advantages of the present invention will be explained and their utility and benefit will become understandable to one skilled in the art through the summary of the invention that follows.

### SUMMARY OF THE INVENTION

As described in further detail herein below, the methods and systems, and devices described herein employ a novel design for spring-loaded hinges which may be configured for use with glasses enabled with wireless communication technology.

In some embodiments, a spring-loaded hinge assembly may comprise a box housing, one or more biasing members, for example, one or more springs, and one or more barrel components, for example five barrel components. In some examples, the barrel components may have male and female configurations. In embodiments with five barrel components, for example, there may be two male barrel components engaged with three female barrel components.

In some embodiments, the hinge assembly may comprise at least a first hinge component pivotally connected to a second hinge component. In some embodiments, the first hinge component may comprise a box housing configured to at least partially house one or more internal components. In some embodiments, the first hinge component and/or its box housing (and any components that may be partially or fully disposed therein) may be configured to be disposed on an end piece of the front frames of smartglasses, instead of, for example, on an end piece of the temples of the smartglasses. Such a configuration may be beneficial to prevent bulking the temples of smartglasses, which already house electronics and related components for enabling wireless communication between the smartglasses and other electronic devices (e.g., smartphones, computers, tablets, and the like) and/or audio capabilities.

In accordance with embodiments of the present invention, at least one of the temples may comprise a printed circuit board, battery, microphone, speakers, connectivity module, cellular communications unit and hardware, and artificial intelligence interface in electronic communication, the connectivity module and the cellular communications unit and hardware configured and programmed to pair or connect the smartglasses to a smartphone, smartwatch, or other devices or systems and support active priority for the smartphone, the smartwatch, or the other device or systems, the smartglasses configured and programmed to receive oral requests or commands at the microphone and artificial intelligence interface to perform mobile device tasks or applications and process and communicate the oral requests or commands to a mobile device application controlling paired or connected devices or systems used for display or presentation of information related to the requested or commanded tasks or applications, the mobile device application and the artificial intelligence interface are programmed or configured to control paired or connected devices used for display or presentation of information related to requested or commanded tasks or applications and to display or present information related to the requested or commanded tasks or applications on the smartglasses, a paired or connected smartwatch, smartphone, or other paired or connected devices or systems, based on default settings, and to activate connections between the paired or connected smartglasses, smartphone, the smartwatch or additional devices or systems having higher priority until a capacity for connection with the smartglasses, the smartphone, the smartwatch, or other paired or connected devices or systems is reached, and receive at the microphone oral commands to override or switch the default settings and display or present information on a paired or connected as specified in the override or switch commands at the microphone and artificial intelligence and process and communicate the oral requests or commands to the mobile device application controlling paired or connected devices used for display or presentation of information related to requested or commanded tasks or applications switch display from a mobile device specified in the default settings to the paired or connected device or devices specified in the switch or override command.

In accordance with embodiments of the present invention, the smartglasses device may be controlled by a smartglasses mobile application, wherein the mobile device application controlling paired or connected devices used for display or presentation of information related to requested or commanded tasks or applications is the smartglasses mobile application.

In accordance with embodiments of the present invention, the front frame may or may not contain electrical wiring that connects to the temples.

In accordance with embodiments of the present invention, the front frame of smartglasses may be configured to pivotally connect to each of the temples through a pair of spring-loaded hinge assemblies without affecting any electronic connection between the temples and the front frame or any devices or systems paired or connected to the temples of the smartglasses.

The inventions described herein also can be implemented with the voice assistant management inventions marketed by Applicant under the trade name VYRB™, which are described in application Ser. No. 16/829,841, filed Mar. 25, 2020, now U.S. Pat. No. 11,282,523, entitled Voice Assistant Management.

It is an object of the present invention to provide a spring-loaded hinge assembly configured for use with eyeglasses, including reading glasses, sunglasses and smartglasses.

It is another object of the present invention to provide a spring-loaded hinge assembly that improves the durability of glasses temples by acting as a sink for excessive bending stress on the temples.

It is another object of the present invention to provide a spring-loaded hinge assembly that increases flexibility of the temples with respect to the front frame of glasses.

It is another object of the present invention to provide a spring-loaded hinge assembly that makes it easier to open and close the temples because of the biasing flexibility (e.g., spring tension) provided by the spring(s) in the hinge system.

It is another object of the present invention to provide a spring-hinge assembly comprising a box housing for housing a spring which is more compact than traditional box housings. For example, the spring(s) disposed in the box housing may be shorter in length than traditional spring-loaded hinge spring(s) and still have the range to act properly (to properly bias the appropriate hinge components). The box housing of the present invention may be formed in a three-dimensional geometry that differs from traditional box housings in that it may have shorter length than a traditional box housing and a longer height than a traditional box housing. Such a configuration, in some instances, in combination with a five-barrel system (e.g., as opposed to a traditional three-barrel system), may support fitting the box housing on a front frame end piece so that the size of a folded pair of glasses (e.g., smartglasses) is not too big (e.g., to fit into a standard eyewear box). Moreover, such a configuration may prevent compromise of the integrity and strength of the end pieces of a front frame in that the end pieces don't have to be too long to support engagement with the box housings.

It is another object of the present invention to provide spring-loaded hinge assembly wherein the spring is housed between a u-shaped element and a post disposed within a first hinge component to support stability of the hinge and/or enable the first hinge component housing to be smaller than traditional hinge component housings.

It is another object of the present invention to provide a spring configured to compress, as opposed to extend, within the first hinge component to direct movement of the male barrel component(s).

It is another object of the present invention to provide a U-shaped component configured to house a spring and which is also formed with the male barrels to enable the box housing to be smaller (e.g., in length) than conventional spring-loaded hinges.

It is another object of the present invention to provide a spring-loaded hinge assembly that includes a temple endcap piece configured to improve durability of the glasses by distributing the load on temples, for example, plastic temples, caused by opening and closing such temples. In some embodiments, the temple endcap may distribute the torsion loads commonly present in smartglasses assemblies due to the typically heavier smartglasses temples configuration (e.g., which is relatively heavier than standard glasses temples) which may be a result of the incorporation of one or more batteries in the smartglasses temples at the rearward end of the temples. Such torsion loads on smartglasses temples may produce micro cracks in temple end pieces which can lead to fatigue and breakage of plastic temples over time after continued use.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still be within the spirit of the invention as described herein.

FIG. 1 shows a front perspective view of smartglasses with a hinge assembly constructed in accordance with an embodiment of the present invention.

FIG. 2 shows a top view of smartglasses with a hinge assembly constructed in accordance with an embodiment of the present invention.

FIG. 3 shows a front perspective view of a hinge assembly constructed in accordance with an embodiment of the present invention.

FIG. 4 shows a rear perspective view of a hinge assembly constructed in accordance with an embodiment of the present invention.

FIG. 5 shows a front view of a hinge assembly constructed in accordance with an embodiment of the present invention with a first hinge component of the hinge assembly transparent to show internal components disposed therein.

FIG. 6 shows a cross-sectional view taken along the line shown in FIG. 3 of a hinge assembly constructed in accordance with an embodiment of the present invention.

FIG. 7 shows a front perspective view of a hinge assembly in a first exemplary extended position in accordance with an embodiment of the present invention with a first hinge component of the hinge assembly transparent to show internal components disposed therein.

FIG. 8 shows a perspective view of a hinge assembly in a second exemplary extended position in accordance with an embodiment of the present invention with a first hinge component of the hinge assembly transparent to show internal components disposed therein.

FIG. 9 shows a front perspective view of smartglasses with a hinge assembly constructed in accordance with an embodiment of the present invention.

FIG. 10 shows a top view of smartglasses with a hinge assembly constructed in accordance with an embodiment of the present invention.

FIG. 11 shows a front perspective view of a hinge assembly constructed in accordance with an embodiment of the present invention.

FIG. 12 shows a rear perspective view of a hinge assembly constructed in accordance with an embodiment of the present invention.

FIG. 13 shows a front view of a hinge assembly constructed in accordance with an embodiment of the present invention with a first hinge component of the hinge assembly transparent to show internal components disposed therein.

FIG. 14 shows a cross-sectional view taken along the line shown in FIG. 12 of a hinge assembly constructed in accordance with an embodiment of the present invention.

### DETAILED DESCRIPTION

The present invention is generally directed toward spring-loaded hinge assemblies which may be utilized in connection with electronic glasses having “smart” functionalities, including the ability to connect to a network to share, transmit and interact with other electronics wirelessly and/or remotely. Specifically, embodiments of the present invention are directed toward electronic glasses which incorporate Bluetooth® or other wireless technologies, including the technologies disclosed in U.S. application Ser. No. 16/022,097 entitled SMARTGLASSES AND METHODS AND SYSTEMS FOR USING ARTIFICIAL INTELLIGENCE TO CONTROL MOBILE DEVICES USED FOR DISPLAYING AND PRESENTING TASKS AND APPLICATIONS AND ENHANCING PRESENTATION AND DISPLAY OF AUGMENTED REALITY INFORMATION, which allow users to transmit and receive communications and data, while also providing users with the flexibility to choose and change the style of the front frame of the device.

In accordance with embodiments of the present invention, a spring-loaded hinge assembly may comprise a first hinge component and a second hinge component. In some examples, the first hinge component and the second hinge component may be configured to be pivotally engaged by means of a pin, screw, or other similar pivotable fastener adapted to enable rotation about its central axis. In some embodiments, though pivotally engaged with one another, the first and second hinge components may be configured to be drawn apart a distance as a spring disposed within the first hinge component is compressed upon rotation of male barrel components of the first hinge component with respect to female barrel components of the second hinge component.

In accordance with embodiments of the present invention, the first hinge component may comprise a box housing, one or more biasing members, for example, one or more springs, and one or more barrel components, for example, a pair of male barrel components integrally formed with, fused to, or otherwise bound to a U-shaped element, and a post component configured to engage with and/or substantially abut the spring(s) and/or abut female barrel components of the second hinge component. The box housing of the first hinge component may house at least a portion of the spring(s), the post component, and/or the U-shaped element. The U-shaped element may have a U-shaped portion which extends towards a pair of legs, each leg having an end piece extending toward (e.g., formed with) a male barrel component. The first hinge component and/or its box housing may have one or more anchor pieces, for example, two anchor pieces extending from a bottom surface thereof. In some embodiments, the anchor pieces may be adapted to engage with and/or secure the first hinge component to an end piece of a front frame to secure the hinge assembly to a front frame.

In accordance with embodiments of the present invention, the second hinge component may comprise one or more barrel components, for example, three female barrel components. The female barrel components may extend from a base portion of the second hinge component. In some examples, the base component of the second hinge component may extend from a platform portion adapted to engage with (e.g., secure to) an end piece of a smarglasses temple. In some examples, a screw may be utilized to secure the base component to an end piece of a smartglasses temple.

In accordance with embodiments of the present invention, the platform portion of the second hinge component may also engaged with, connected to, or otherwise formed with an endcap component adapted to be an end cap of a smartglasses temple. In some embodiments, the endcap piece may be configured to improve durability of glasses by distributing the load on temples, for example, plastic temples, caused by opening and closing such temples. In some embodiments, the temple endcap may be extend from the second hinge component (e.g., from a bottom or side portion of the second hinge component) and may be configured to distribute the torsion loads commonly present in smartglasses assemblies due to the typically heavier smartglasses temples configuration (e.g., which is relatively heavier than standard glasses temples) which may be a result of the incorporation of one or more batteries in the smartglasses temples at the rearward end of the temples. Such torsion loads on smartglasses temples may produce micro cracks in temple end pieces (e.g., temple end pieces without the end caps disclosed herein) which can lead to fatigue and breakage of plastic temples over time after continued use.

In accordance with embodiments of the present invention, the barrel components of the first and second hinge components may have male and female configurations to support mating of the components. In some examples, each of the male and female barrel components may be formed with an opening configured to receive a pin, screw, screw, or the like pivotable fasteners, adapted to pivotally secure the male and female barrel components to one another and enable rotation about a central axis of the screw. In embodiments with five barrel components, for example, there may be two male barrel components and three female barrel components, configured to mate (e.g., engage) with one another. For example, a single male barrel component may be configured to be disposed between a pair of female barrel components. In some examples, the female components may be configured to be of different widths, for example, a central female barrel component may be configured to be of a greater width than an external female barrel component. In some examples, the width of a barrel component (e.g., a greater width), for example, the greater width of the central female barrel component, may contribute to or support the stabilization of the hinge assembly. In accordance with an exemplary embodiment, each of the two male barrel components in a hinge system may be disposed between a central female barrel component and an external female barrel component.

In some embodiments, the post component of the first hinge component may have a cross-section formed in any shape, including T-shaped and X-shaped, and including any geometrical shape, for example, the shape of a square, rectangle, triangle, trapezoid, rhombus or any other similarly suitable geometric shape.

In accordance with embodiments of the present invention, the post component may be in mechanical communication with one or more spring components of the hinge assembly and the spring may be disposed between the U-shaped portion of the U-shaped element and the post component.

In accordance with embodiments of the present invention, the post component may abut or may be integrally formed with, fused to, or otherwise adhered to a spring.

In accordance with embodiments of the present invention, the post component may be configured to remain stationary, even as the spring within the U-shaped element is compressed to draw the u-shaped portion of the U-shaped element towards the post. For example, the post component may be configured to remain stationary while the connection of the male barrel components to the female barrel components draws the u-shaped portion of the u-shaped element towards the second hinge component as the first hinge component rotates with respect to the second hinge component. Moreover, for example, the post component may support the biasing of the spring towards the u-shaped portion of the U-shaped element and may act as a stationary wall against which the spring may be compressed as the U-shaped element is drawn towards the second hinge component (e.g., towards the female barrel components of the second hinge component) as the first hinge component is rotated relative to the second hinge component.

In accordance with embodiments of the present invention, the spring utilized in the hinge assembly should be of a sufficient size (e.g., length and width) and hardness (e.g., stiffness) to allow the spring to act (e.g., compress) properly. For this reason, the U-shaped element should have sufficient internal space to house a spring of the appropriate size and hardness to allow a proper spring to act properly within the system. To illustrate this, too small a box housing and/or U-shaped element would limit the length of spring that may fit within such components, which may require that a harder (or softer) spring be utilized within the system. However, too hard a spring would stiffen the system, whereas a soft spring would make the system to soft and unstable.

In accordance with embodiments of the present invention, when spring-loaded hinges are used in conjunction with glasses, the tension and compressibility of the spring housed within the U-shaped element, which itself may be housed within the box housing, may support flexibility of the pivotable connection between the temples and the front frames of glasses, and may allow for overextension of the temples relative to the front frames when the spring is compressed, for example, by human force when putting on a pair of glasses.

In accordance with embodiments of the present invention, a spring-loaded hinge assembly may comprise more than one biasing component, for example, more than one spring, to disperse the tension in the hinge among more than one hinge. As discussed above, each of the spring components may be engaged or in mechanical communication one or more post components of the hinge system to support the biasing and flexibility of the hinge system.

In accordance with embodiments of the present invention, the box housing of the first hinge component may be configured to be disposed on the front frame of glasses (e.g., smartglasses), for example, at the end piece of the front frame, and, upon rotation of the first hinge component with respect to the second hinge component, the spring component(s) may be configured to compress to allow the male barrel components extending from the U-shaped element to extend a distance past the box housing of the first hinge component to create a distance between the female barrel components and the first hinge component and permit over-extension (e.g., extension of over 90 degrees) of the hinge assembly.

In accordance with embodiments of the present invention where the box housing of the hinge assembly is configured to be disposed on an end piece of the front frames of smartglasses, such a configuration may be beneficial to prevent bulking the temples of smartglasses and enable spring-loaded hinge assemblies to be used in conjunction with “smart” eyewear, which already house electronics and related components for enabling wireless communication between the smartglasses and other electronic devices (e.g., smartphones, computers, tablets, and the like).

In accordance with embodiments of the present invention, at least one of the temples may comprise a printed circuit board, memory, battery, camera, microphone, speakers, connectivity module, cellular communications unit and hardware, and artificial intelligence interface in electronic communication, the connectivity module and the cellular communications unit and hardware configured and programmed to pair or connect the smartglasses to a smartphone, smartwatch, or other devices or systems and support active priority for the smartphone, the smartwatch, or the other device or systems, the smartglasses configured and programmed to receive oral requests or commands at the microphone and artificial intelligence interface to perform mobile device tasks or applications and process and communicate the oral requests or commands to a mobile device application controlling paired or connected devices or systems used for display or presentation of information related to the requested or commanded tasks or applications, the mobile device application and the artificial intelligence interface are programmed or configured to control paired or connected devices used for display or presentation of information related to requested or commanded tasks or applications and to display or present information related to the requested or commanded tasks or applications on the smartglasses, a paired or connected smartwatch, smartphone, or other paired or connected devices or systems, based on default settings, and to activate connections between the paired or connected smartglasses, smartphone, the smartwatch or additional devices or systems having higher priority until a capacity for connection with the smartglasses, the smartphone, the smartwatch, or other paired or connected devices or systems is reached, and receive at the microphone oral commands to override or switch the default settings and display or present information on a paired or connected as specified in the override or switch commands at the microphone and artificial intelligence and process and communicate the oral requests or commands to the mobile device application controlling paired or connected devices used for display or presentation of information related to requested or commanded tasks or applications switch display from a mobile device specified in the default settings to the paired or connected device or devices specified in the switch or override command.

In accordance with embodiments of the present invention, the smartglasses device may be controlled by a smartglasses mobile application, wherein the mobile device application controlling paired or connected devices used for display or presentation of information related to requested or commanded tasks or applications is the smartglasses mobile application.

In accordance with embodiments of the present invention, the front frame may contain no electrical wiring that connects to the temples. Moreover, the front frame may be configured to be pivotably connected to each of the temples without affecting any electronic connection between the temples and the front frame and any devices or systems paired or connected to the temples of the smartglasses.

In accordance with embodiments of the present invention, a smartglasses device may comprise a front frame comprising a bridge member connecting a pair of rims having a pair of lenses disposed therein, and a pair of spring-loaded hinge assemblies. The smartglasses device may further comprise a pair of temples, each engageable with a hinge assembly adapted to pivotably connect the temple to the front frames, the temples further comprising a connectivity module configured to wirelessly connect the temples to a mobile device.

In accordance with embodiments of the present invention, the measurements of the box housing may be as follows (+/−0.1-0.5 nm): 8.3 nm in length, 4.3 nm in width, and 3.0-3.2 nm in height.

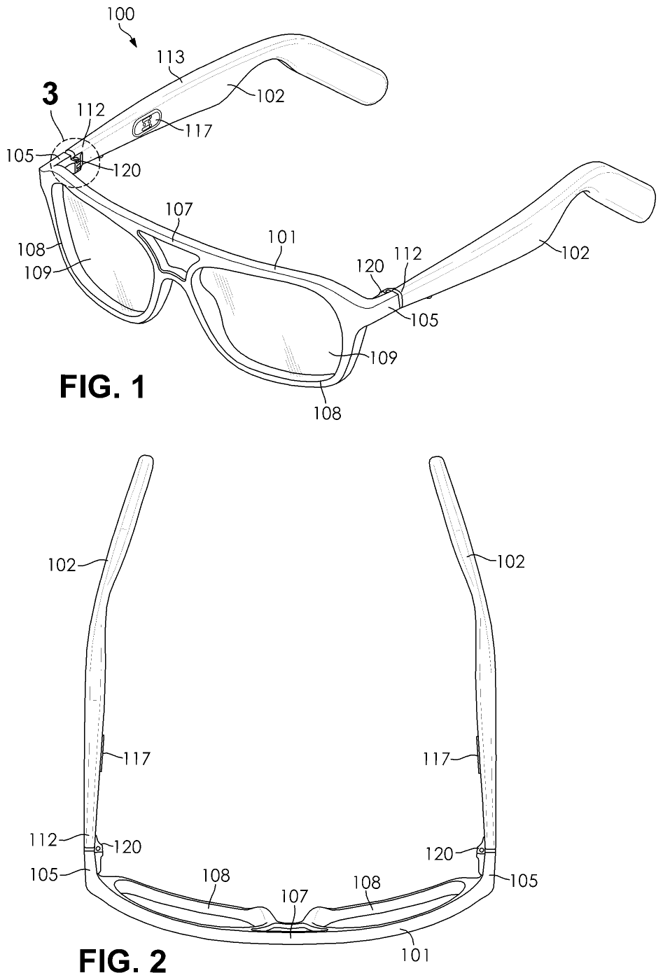

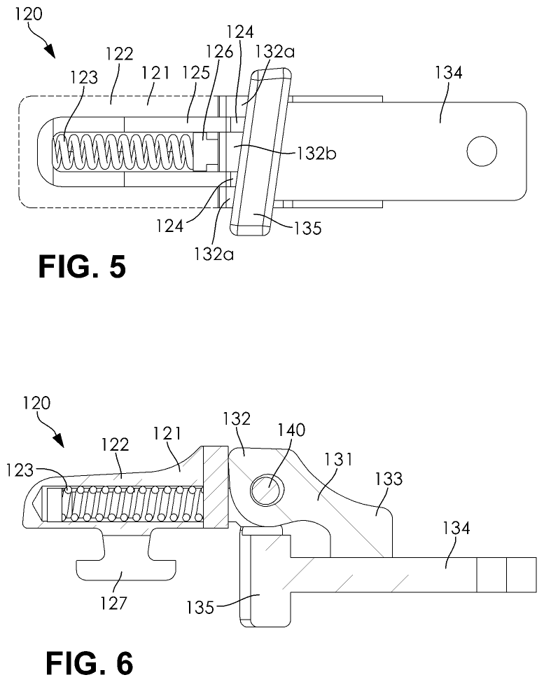

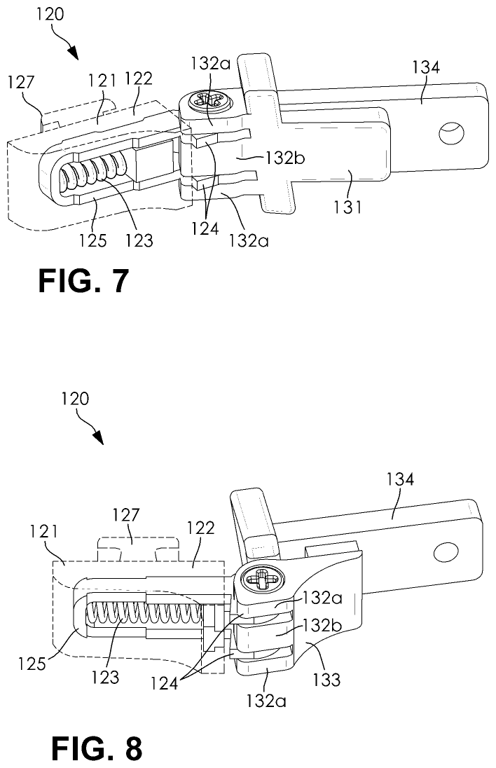

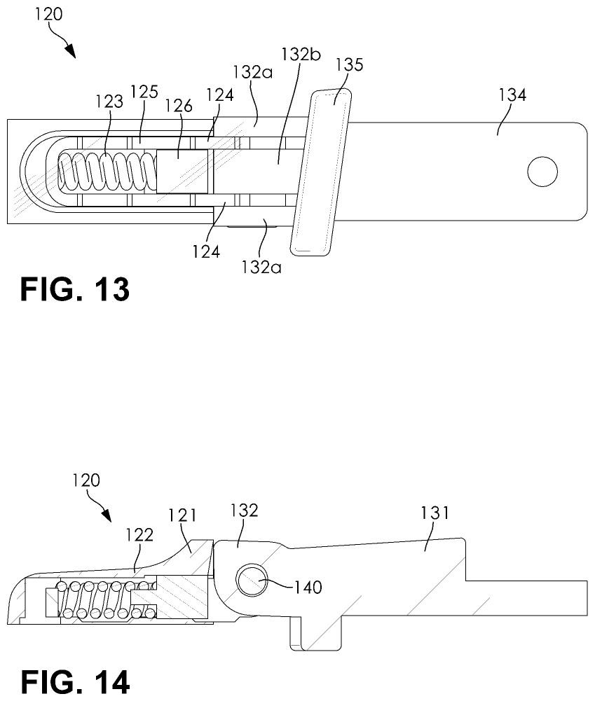

Turning now to the figures, FIGS. 1-14 demonstrate exemplary embodiments of the present invention wherein a spring-loaded hinge may be configured to pivotably connect a front frame to a temple of a pair of glasses, the temple configured with wireless communication and audio transmission technology.

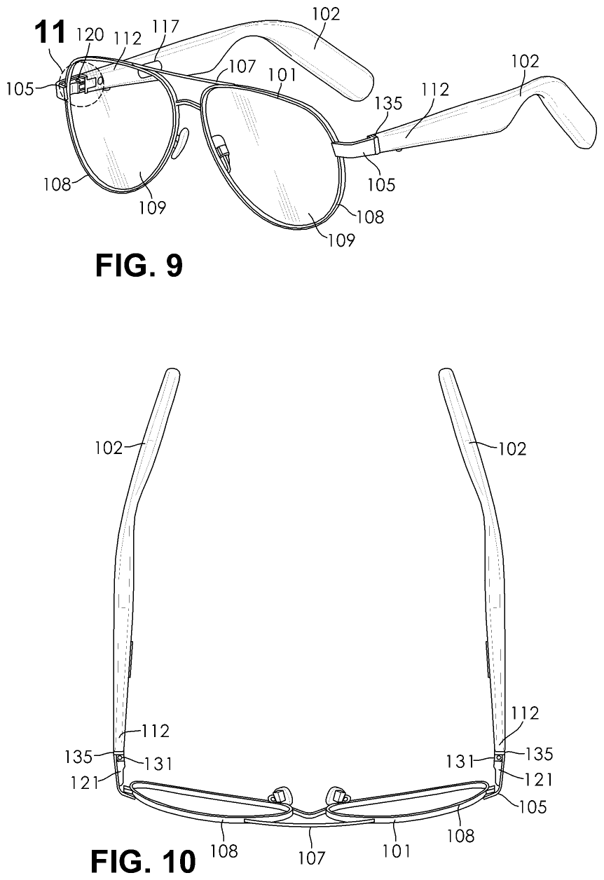

FIGS. 1-2 and FIGS. 9-10 demonstrate perspective and top views, respectively, of a pair of exemplary smartglasses having a pair of spring-loaded hinges pivotably connecting a pair of temples to the front frames of the smartglasses in accordance with embodiments of the present invention. While the front frame member depicted in FIGS. 1-2 is described and/or shown as being plastic and/or aviator shaped, and the front frame member depicted in FIGS. 9-10 is described and/or shown as being metal and/or aviator shaped, the hinge assemblies described herein may be employed with smartglasses of other materials, shapes, colors, and styles. In the depicted embodiment, smartglasses 100 comprise a front frame member 101 pivotably connected to a pair of temples 102 by means of a pair of spring-loaded hinge assemblies.

The temples 102 of the glasses 100 may include wireless technology, for example, Bluetooth® technology for connecting the glasses to a mobile phone, tablet, or other smart device in order to permit the transmission or playing of music and other audio by the glasses 100. In some embodiments, the temples 102 include a microphone (not shown), battery (not shown), speakers, for example, bone conduction speakers (not shown), one or more printed circuit boards (not shown), a control pad (not shown), a connectivity module and hardware (not shown), and a cellular communications unit and hardware (not shown) which may be configured to enable the glasses 100 to communicate over a wireless network, for example, Bluetooth® wireless networks, cellular wireless networks, WiFi, near field communication and/or other types of wireless technology standards to pair and/or communicate with other electronic devices, for example, mobile devices including smartphones and smartwatches. In some embodiments, other components which are not depicted in the exemplary embodiments disclosed herein, may be incorporated into the smartglasses 100.

As shown in FIGS. 1-2 and FIGS. 9-10, in accordance with embodiments of the present invention, each of the temples 102 may include an temple end piece 112, a housing section 113 configured as an electronics housing, and a temple tip 114. In some embodiments, a substantial portion of the electronics components may be generally disposed within the temple housing section 113. As shown in the illustrated examples, the temples may each comprise a charging port 117. In some embodiments, each of the temple end pieces 112 may be configured to engage with at least a portion of a hinge assembly 120 pivotably connected to a front frame member 101.

As further shown in FIGS. 1-2 and FIGS. 9-10, in accordance with embodiments of the present invention, the front frame member 101 may comprise a bridge 107 comprising one or more bridge portions, and rims 108 adapted to receive lenses 109. In some examples, the front frame member 101 may comprise a pair end pieces 105. In some embodiments, each of the front frame end pieces 105 may be configured to engage with at least a portion of a hinge assembly 120 pivotably connected to a temple end piece 112.

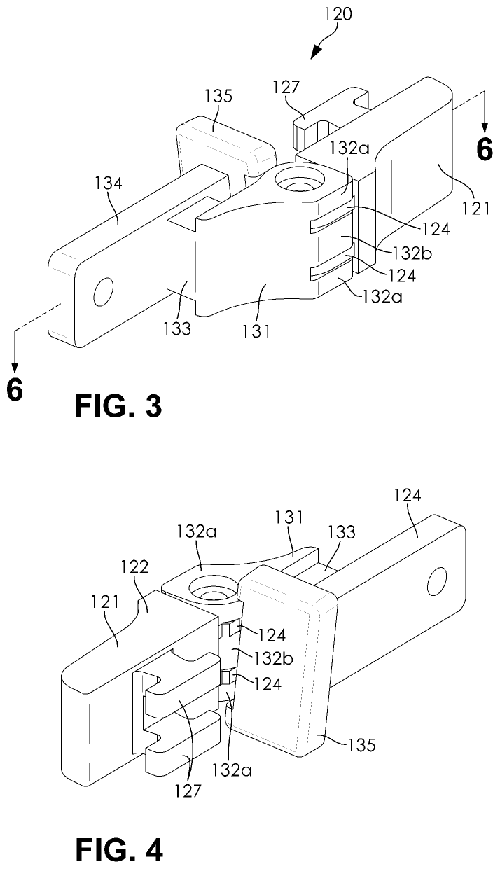

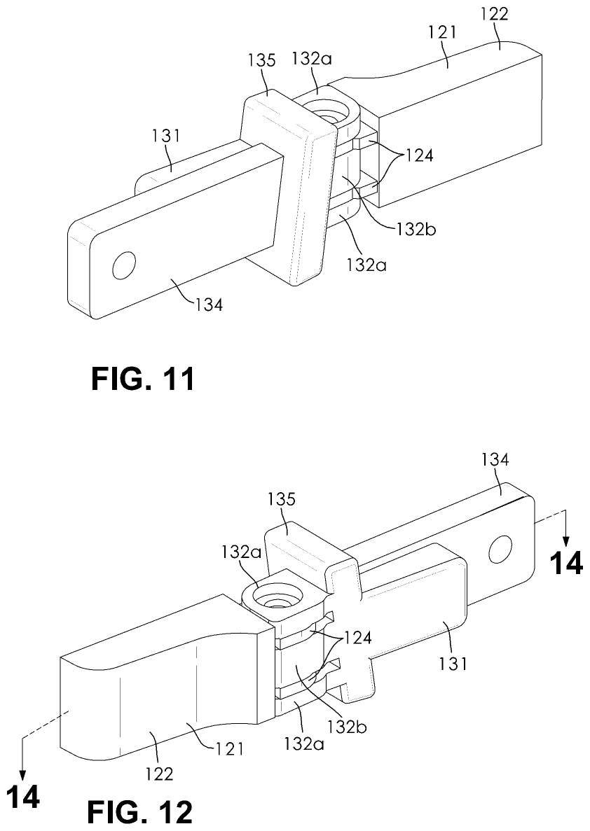

FIGS. 3-8 generally demonstrate a hinge assembly configured for use with plastic glasses configurations (as shown in FIGS. 1-2) and FIGS. 11-14 generally demonstrate a hinge assembly configured for use with metal glasses configurations (as shown in FIGS. 9-10). That said, the hinge assemblies shown in FIGS. 1-8 are also contemplated for use in association with metal glasses, and the hinge assemblies shown in FIGS. 9-14 are also contemplated for use in association with plastic glasses.

As demonstrated in FIGS. 3-8 and 11-14, in accordance with embodiments of the present invention, a spring-loaded hinge assembly 120 may comprise a first hinge component 121 and a second hinge component 131. In some examples, the first hinge component 121 and the second hinge component 131 may be configured to be pivotally engaged by means of a pivotable fastener, for example, a screw 140, adapted to enable rotation about the screw 140 central axis.

In accordance with embodiments of the present invention, the first hinge component 121 may comprise a box housing 122, one or more biasing members, for example, one or more springs 123, and one or more barrel components, for example, a pair of male barrel components 124 integrally formed with, fused to, or otherwise bound to a U-shaped element 125, the pair of male barrel components 124 configured to mate with female barrel components 132 of the second hinge component 131, and a post component 126 configured to engage with and/or substantially abut the spring(s) 123 and/or abut a u-shaped portion of the U-shaped element 125. The box housing 122 of the first hinge component 121 may house at least a portion of the spring(s) 123, the post component 126, and/or the U-shaped element 125.

In some embodiments, the post component 126 may have a cross-section formed in any shape, including T-shaped and X-shaped, and including any geometrical shape, for example, the shape of a square, rectangle, triangle, trapezoid, rhombus or any other similarly suitable geometric shape.

As shown in FIGS. 1-2 and 9-10, a first hinge component 121 and/or its box housing 122 of the hinge assembly 120 may be configured to be disposed on an end piece 105 of the front frame 101 to prevent bulking of the glasses temples 102. In some embodiments, the first hinge component 121 and/or its box housing 122 may have one or more anchor pieces, for example, two anchor pieces 127, extending from a bottom surface thereof. In some embodiments, the anchor pieces 127 may be adapted to engage with and/or secure the first hinge component 121 to an end piece 105 of a front frame 101 to secure the hinge assembly 120 to the front frame 101. In some examples, adhesives, for example, glues, screws, or other adhesive materials, may be utilized to secure the first hinge component 121 to the end pieces 105 of the front frame 101, and the anchor pieces 127 may be configured to support securement of the components. Additionally or alternatively, the first hinge component 121 may be configured to engage with or secure to a temple end piece 112.

In accordance with embodiments of the present invention, the second hinge component 131 may comprise one or more barrel components, for example, three female barrel components 132. The female barrel components 132 may extend from a base portion 133 of the second hinge component 131. In some examples, the base component 133 of the second hinge component 131 may extend from a platform portion 134 adapted to engage with an end piece 112 of a smarglasses temple 102. The platform portion 134 may also be engaged with or otherwise connected to an endcap piece or component 135 adapted to be an end cap of a smartglasses temple. In some embodiments, the endcap piece 135 may be configured to improve durability of glasses 100 by distributing the load on temples 102, for example, plastic temples, caused by opening and closing such temples 102. In some embodiments, a temple endcap piece 135 may be extended from the second hinge component 131 (e.g., from a bottom or side portion of the second hinge component 131) and may be configured to distribute the torsion loads commonly present in smartglasses assemblies due to the typically heavier smartglasses temples 102 configuration (e.g., which is relatively heavier than standard glasses temples) which may be a result of the incorporation of one or more batteries in the smartglasses temples 102 at the rearward end of the temples 102. Such torsion loads on smartglasses temples 102 are typically expected to produce micro cracks in plastic temple end pieces 112 in glasses of the prior art which can lead to fatigue and breakage of such plastic temples 102 over time after continued use.

In accordance with embodiments of the present invention, the barrel components 124, 132 of the first and second hinge components 121, 131 may have male and female configurations to support mating of the components. In some examples, the male barrel components 124 and the female barrel components 132 may be formed with an opening configured a pivotable fasteners, for example, a screw 140, adapted to pivotally secure the male and female barrel components 124, 132 to one another and enable rotation about a central axis of the screw 140. In embodiments with five barrel components, for example, there may be two male barrel components 124 and three female barrel components 132, configured to mate (e.g., engage) with one another. For example, a single male barrel component 124 may be configured to be disposed between a pair of female barrel components 132. In some examples, the female components 132 may be configured with different widths, for example, an external female barrel component 132a may be configured to be of a smaller width than a central female barrel component 132b. In accordance with an exemplary embodiment, each of the two male barrel components 124 in a hinge system may be disposed between a central female barrel component 132b and an external female barrel component 132a.

As shown in particular in FIGS. 3-8 and FIGS. 13-14, in accordance with embodiments of the present invention, the post component 126 may be in mechanical communication with one or more spring components 123 of the hinge assembly 120 and the spring 123 may be disposed between the u-shaped portion of the U-shaped element 125 and the post component 126.

In accordance with embodiments of the present invention, the post component 126 may abut or may be integrally formed with, fused to, or otherwise adhered to the spring 123.

In accordance with embodiments of the present invention, the post component 126 may be configured to remain stationary, even as the spring 123 within the U-shaped element 125 is compressed to draw the u-shaped portion of the U-shaped element 125 towards the post component 126. In some examples, the pivotal connection of the male barrel components 124 to the female barrel components 132 may draw the U-shaped portion of the U-shaped element 125 towards the second hinge component 131 as the first hinge component 121 rotates with respect to the second hinge component 132. Moreover, for example, the post component 126 may support the biasing of the spring 123 towards the U-shaped portion of the U-shaped element 125 and may act as a stationary wall against which the spring 123 may be compressed as the U-shaped element 125 is drawn towards the second hinge component 131 (e.g., towards the female barrel components 132 of the second hinge component 131) as the first hinge component 121 is rotated relative to the second hinge component 131.

In accordance with embodiments of the present invention, when spring-loaded hinges of the present invention are used in conjunction with smartglasses 100, the tension and compressibility of the spring(s) 123 housed within the U-shaped element 125, which itself may be housed within the box housing 122, may support flexibility of the pivotable connection between the temples 102 and the front frames of glasses 101, and may allow for overextension of the temples 102 relative to the front frames 101 when the spring(s) 123 is compressed, for example, by human force when putting on a pair of smartglasses 100.

In accordance with embodiments of the present invention, a spring-loaded hinge assembly 120 may comprise more than one biasing component, for example, more than one spring 123, to disperse the tension in the hinge 120 among more than one spring 123. As discussed above, each of the spring components 123 may be engaged or in mechanical communication one or more post components 126 of the hinge system 120 to support the biasing and flexibility of the hinge system 120.

In accordance with embodiments of the present invention, the hinge assemblies 120 may be configured as flexible, spring loaded hinges 121 that enable the temples 102 of the glasses 100 to extend beyond ninety degrees relative to the front frame member 101. In some examples, the temples 102 may be configured to connect to the front frame 101 via flexible, spring loaded hinges 121, to enable the temples 102 of the glasses 100 to be extended beyond ninety degrees relative to the front frame member 101. With such a configuration, the spring 123 itself may take the majority of the force when the temples of the smartglasses 100 bend and twist, allowing the spring-loaded hinge 120 to retain its initial balance and fit without the need for subsequent fit adjustment.

In accordance with several embodiments of the present invention, the wireless communication technology of the glasses device 100 may be configured to function despite pivotably connecting the temples 102 to the front frame member 101 by means of a spring-loaded hinge assembly.

In accordance with several embodiments of the present invention, the front frame member 101 may be glasses with or without outer rims.

In accordance with embodiments of the present invention, the temples 102 of the glasses 100 can include wireless technology, for example, Bluetooth® technology for connecting the glasses to a mobile phone, tablet, or other smart device in order to permit the transmission or playing of music and other audio by the glasses 100 through bone conduction speakers 110. In some embodiments, the temples 102 may transmit music and other audio by the glasses 100 through in-ear or over-ear headphones disposed near the temple tips 114.

The present system may be readily realized in a network communications system. The system may include one or more client devices, and one or more host devices. The system may include a variety of client devices, such as desktop computers and the like, which typically include a display, which is a user display for providing information to users, and various interface elements as will be discussed in further detail below. A client device may be a mobile device, which may be a cellular phone, a personal digital assistant, a laptop computer, a tablet computer, etc. The client devices may communicate with the host device via a connection to one or more communications channels such as the Internet or some other data network, including, but not limited to, any suitable wide area network or local area network. It should be appreciated that any of the devices described herein may be directly connected to each other instead of over a network. Typically, one or more servers may be part of the network communications system, and may communicate with host servers and client devices.

One host device may interact with a large number of users at a plurality of different client devices. Accordingly, each host device is typically a high end computer with a large storage capacity, one or more fast microprocessors, and one or more high speed network connections. Conversely, relative to a typical host device, each client device typically includes less storage capacity, a single microprocessor, and a single network connection. It should be appreciated that a user as described herein may include any person or entity which uses the presently disclosed system and may include a consumer or purchaser of smartglasses.

Typically, host devices and servers store one or more of a plurality of files, programs, databases, and/or web pages in one or more memories for use by the client devices, and/or other host devices or servers. A host device or server may be configured according to its particular operating system, applications, memory, hardware, etc., and may provide various options for managing the execution of the programs and applications, as well as various administrative tasks. A host device or server may interact via one or more networks with one or more other host devices or servers, which may be operated independently.

The electrical systems of an example computing device (e.g., a client device, and a host device includes a main unit which preferably includes one or more processors electrically coupled by an address/data bus to one or more memory devices, other computer circuitry, and one or more interface circuits. The processor may be any suitable processor, such as a microprocessor from the INTEL PENTIUM® family of microprocessors. The memory preferably includes volatile memory and non-volatile memory. Preferably, the memory stores a software program that interacts with the other devices in the system as described below. This program may be executed by the processor in any suitable manner. In an example embodiment, memory may be part of a “cloud” such that cloud computing may be utilized by computing devices. The memory may also store digital data indicative of documents, files, programs, web pages, etc. retrieved from a computing device and/or loaded via an input device.

Interface circuits may be implemented using any suitable interface standard, such as an Ethernet interface and/or a Universal Serial Bus (USB) interface. One or more input devices may be connected to the interface circuit for entering data and commands into the main unit. For example, the input device may be a keyboard, mouse, touch screen, track pad, track ball, isopoint, image sensor, character recognition, barcode scanner, microphone, and/or a speech/voice recognition system. One or more displays, printers, speakers, and/or other output devices may also be connected to the main unit via the interface circuit. The display may be a cathode ray tube (CRTs), a liquid crystal display (LCD), or any other type of display. The display generates visual displays generated during operation of the computing device. For example, the display may provide a smartglasses seller or service provider interface, which may display one or more web pages received from a computing device. An interface may include prompts for human input from a user including links, buttons, tabs, checkboxes, thumbnails, text fields, drop down boxes, etc., and may provide various outputs in response to the user inputs, such as text, still images, videos, audio, and animations.

One or more storage devices may also be connected to the main unit via the interface circuit. For example, a hard drive, CD drive, DVD drive, and/or other storage devices may be connected to the main unit. The storage devices may store any type of data, such as pricing data, transaction data, operations data, inventory data, commission data, manufacturing data, image data, video data, audio data, tagging data, historical access or usage data, statistical data, security data, etc., which may be used by the computing device.

The computing device may also exchange data with other network devices via a connection to the network. Network devices may include one or more servers, which may be used to store certain types of data, and particularly large volumes of data which may be stored in one or more data repository. A server may include any kind of data including databases, programs, files, libraries, pricing data, transaction data, operations data, inventory data, commission data, manufacturing data, configuration data, index or tagging data, historical access or usage data, statistical data, security data, etc. A server may store and operate various applications relating to receiving, transmitting, processing, and storing the large volumes of data. It should be appreciated that various configurations of one or more servers may be used to support and maintain the system. Also, certain data may be stored in a client device which is also stored on the server, either temporarily or permanently, for example in memory or storage device. The network connection may be any type of network connection, such as an Ethernet connection, digital subscriber line (DSL), telephone line, coaxial cable, wireless connection, etc.

Access to a computing device can be controlled by appropriate security software or security measures. An individual users' access can be defined by the computing device and limited to certain data and/or actions. Accordingly, users of the system may be required to register with one or more computing devices.

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

1. A spring-loaded hinge for glasses, comprising:
a first hinge component comprising:
a box housing;
a u-shaped element having a u-shaped portion extending towards a pair of legs, each leg having an end piece formed with a male barrel component;
a post;
a spring disposed between the u-shaped portion of the u-shaped element and the post and configured to compress upon movement of the u-shaped portion, and
a second hinge component comprising at least two female barrel components, the female barrel components configured to receive at least a portion of the male barrel components.

2. The spring-loaded hinge for glasses of claim 1, wherein each of the male barrel components is formed with a male barrel opening and each of the female barrel components are formed with a female barrel opening, and the female barrel openings configured to align with the male barrel openings of the male barrel components and receive a screw therethrough.

3. The spring-loaded hinge for glasses of claim 1, wherein the post abuts at least one female barrel component.

4. The spring-loaded hinge for glasses of claim 1, wherein each of the hinges is flexible.

5. The spring-loaded hinge for glasses of claim 1, wherein the hinge enables a smartglasses temple to be extended beyond ninety degrees relative to a smartglasses front frame.

6. The spring-loaded hinge for glasses of claim 1, wherein the first hinge component is configured to be disposed on an end piece of a smartglasses front frame and the second hinge component is configured to be disposed on an end piece of a smartglasses temple.

7. The spring-loaded hinge for glasses of claim 1, wherein rotation of the first hinge component with respect to the second hinge component about an axis of a screw connecting the male and female barrels of the hinge components directs the spring housed within the U-shaped element to compress, allowing the male barrel components formed with the U-shaped element to move a distance away from the box housing of the first hinge component.

8. The spring-loaded hinge for glasses of claim 1, wherein movement of the U-shaped element within the box housing compresses the spring against the post component.

9. A smartglasses device comprising:
a pair of spring-loaded hinges configured to pivotally connect a pair of temples to a front frame of smartglasses, each spring-loaded hinge comprising:
a first hinge component comprising:
a u-shaped element having a u-shaped portion extending towards a pair of legs, each leg having an end piece formed with a male barrel component;
a post;
a spring disposed between the u-shaped portion of the u-shaped element and the post and configured to compress upon movement of the u-shaped portion, and
a second hinge component comprising at least two female barrel components, the female barrel components configured to receive at least a portion of the male barrel components.

10. The smartglasses device of claim 9, wherein each first hinge component is disposed on an end piece of the front frames and each second hinge component is disposed on an end piece of the temples.

11. The smartglasses device of claim 9, wherein the U-shaped element is configured to compress the spring against the post to move the male barrel components extending from the U-shaped element a distance past the box housing to enable over-extension of the hinge past ninety degrees.

12. The smartglasses device of claim 9, wherein the box housing of the first hinge component is smaller than traditional box housings configured to house traditional spring-loaded hinges springs.

13. The smartglasses device of claim 9, wherein the second hinge component is formed with an endcap configured to distribute and decrease torsion loads on the smartglasses device.

14. A smartglasses device comprising:
a pair of spring-loaded hinges configured to pivotally connect a pair of temples to a front frame of smartglasses, each spring-loaded hinge comprising:
a first hinge component comprising:
a u-shaped element having a u-shaped portion extending towards a pair of legs, each leg having an end piece formed with a male barrel component;
a post;
a spring disposed between the u-shaped portion of the u-shaped element and the post and configured to compress upon movement of the u-shaped portion, and
a second hinge component comprising at least two female barrel components, the female barrel components configured to receive at least a portion of the male barrel components.

15. The smartglasses device of claim 14, wherein at least one of the temples comprises a printed circuit board, a battery, a microphone, one or more speakers, a connectivity module, a cellular communications unit, and an artificial intelligence interface in electronic communication.

16. The smartglasses device of claim 15, wherein the connectivity module and the cellular communications unit are configured and programmed to pair or connect the smartglasses to a smart device and support active priority the smart device.

17. The smartglasses device of claim 16, wherein the smartglasses are configured and programmed to receive oral requests or commands at the microphone and artificial intelligence interface to perform mobile device tasks or applications and process and communicate the oral requests or commands to a mobile device application controlling paired or connected devices or systems used for display or presentation of information related to the requested or commanded tasks or applications.

18. The smartglasses of claim 14, wherein the front frame contains no electrical wiring that connects to the temples.

19. The smartglasses of claim 14, wherein the hinge enables a smartglasses temple to be extended beyond ninety degrees relative to a smartglasses front frame.
